(19) United States
(12) Patent Application Publication
(10) Pub. No.: US 2023/0012904 A1
(43) Pub. Date: Jan. 19, 2023

(54) HISTORY PREVIEW AND SHORTCUT TO RESTORE A WORK SCENE FOR A REMOTE APP

(71) Applicant: CITRIX SYSTEMS, INC., FORT LAUDERDALE, FL (US)

(72) Inventors: TIANYU XIAO, NANJING CITY (CN); PENG YAO, NANJING CITY (CN)

(21) Appl. No.: 17/443,028

(22) Filed: Jul. 20, 2021

Related U.S. Application Data
(63) Continuation of application No. PCT/CN2021/105375, filed on Jul. 9, 2021.

(51) Int. Cl. G06F 9/445; G06F 16/27; G06F 11/14

(52) U.S. Cl. CPC G06F 9/445; G06F 16/27; G06F 11/1469; G06F 2201/84

(57) ABSTRACT

A computing system includes a computing device configured to select a remote app to be launched based on user input, and display a history record of the selected remote app. The history record provides a preview of items previously handled by the user with the remote app. One of the items is selected based on user input. An operation record server is configured to store app history data provided by the remote app corresponding to the items previously handled by the user with the remote app. The remote app is launched with the app history data associated with the selected item so that the remote app is restored back to the item previously handled by the user.

### RELATED APPLICATIONS

This application is a continuation of PCT application serial no. PCT/CN2021/105375 filed Jul. 9, 2021, which is hereby incorporated herein in its entirety by reference.

### Technical Field

The present disclosure relates to computing systems, and more particularly, to a computing system that launches a remote app restored to an item previously handled by the remote app.

### BACKGROUND

In a typical work day, users are able to access an ever-increasing amount of information through their computing devices. This information is readily accessible from a wide range of workspace resources, one category of which is applications. These applications can be SaaS apps and web apps, which may also be referred to as remote apps.

When a user returns to their computing device, the user is able to view a recent apps area in their workspace. The recent apps area allows a user to launch the apps and access previous items handled by the user with the apps.

### SUMMARY

A server includes a memory configured to store app history data provided by a remote app corresponding to items previously handled by a user of a computing device with the remote app. A processor is coupled to the memory and is configured to synch the app history data with the computing device to provide a history record of the remote app. The history record may provide a preview of the items previously handled by the user with the remote app.

The processor may receive from the computing device user selection of one of the items previously handled by the user with the remote app. The remote app is then launched with the app history data associated with the selected item so that the remote app is restored back to the item previously handled by the user.

The memory may receive the app history data form the remote app in response to the user of the computing device closing the remote app. The memory may not receive the app history data while the user is performing a task with the restored selected item. The stored app history data is updated each time the remote app is closed.

The app history data may include metadata. The app history data may further include a respective title for each item previously handled by the user with the remote app, and wherein synching the app history data may be based on providing the respective title for each item to the computing device.

The respective title for each item may be linked to the app history data associated with that item. The history record may include the respective title for each item, with the preview of the items previously handled by the user including the respective title for each item. The user selection of one of the items received by the processor may correspond to the respective title associated with the selected item.

Each item previously handled by the user of the computing device is based on the remote app receiving user input so that activities are performed by the remote app. The remote app may be a SaaS app or a web app.

Another aspect is directed to a method for operating the operation record sever as described above. The method includes storing app history data provided by a remote app corresponding to items previously handled by a user of a computing device with the remote app. The app history data is synched with the computing device to provide a history record of the remote app, with the history record providing a preview of the items previously handled by the user with the remote app. User selection of one of the items previously handled by the user with the remote app is received from the computing device. The method further includes launching the remote app with the app history data associated with the selected item so that the remote app is restored back to the item previously handled by the user.

Yet another aspect is directed to a computing system comprising a computing device and an operation record server. The computing device is configured select a remote app to be launched based on user input, and display a history record of the selected remote app. The history record provides a preview of items previously handled by the user with the remote app. The user then selects one of the displayed items based on user input.

The operation record server is configured to store app history data provided by the remote app corresponding to the items previously handled by the user with the remote app. The remote app is launched with the app history data associated with the selected item so that the remote app is restored back to the item previously handled by the user.

### BRIEF DESCRIPTION OF THE DRAWINGS

FIG. 1 is a schematic block diagram of a network environment of computing devices in which various aspects of the disclosure may be implemented.

FIG. 2 is a schematic block diagram of a computing device useful for practicing an embodiment of the client machines or the remote machines illustrated in FIG. 1.

FIG. 3 is a schematic block diagram of a cloud computing environment in which various aspects of the disclosure may be implemented.

FIG. 4 is a schematic block diagram of desktop, mobile and web based devices operating a workspace app in which various aspects of the disclosure may be implemented.

FIG. 5 is a schematic block diagram of a workspace network environment of computing devices in which various aspects of the disclosure may be implemented.

FIG. 6 is a schematic block diagram of a computer system with an operation record server providing a shortcut to restore a work scene for a remote app in which various aspects of the disclosure may be implemented.

FIG. 7 is a screenshot illustrating display of a history record of the remote app illustrated in FIG. 6.

FIG. 8 is a high level sequence diagram showing operation of the computing system 300 illustrated in FIG. 6.

FIG. 9 is a detailed sequence diagram showing operation of the computing system 300 illustrated in FIG. 6.

FIG. 10 is a flow diagram for operating the operation record server illustrated in FIG. 6.

### DETAILED DESCRIPTION

The present description is made with reference to the accompanying drawings, in which exemplary embodiments are shown. However, many different embodiments may be used, and thus the description should not be construed as limited to the particular embodiments set forth herein. Rather, these embodiments are provided so that this disclosure will be thorough and complete. Like numbers refer to like elements throughout, and prime notation is used to indicate similar elements in different embodiments.

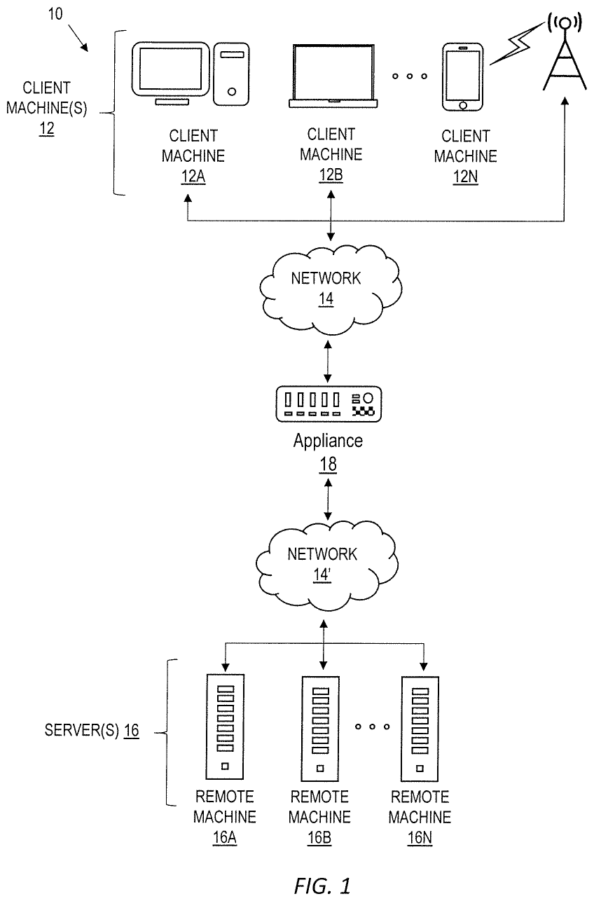

Referring initially to FIG. 1, a non-limiting network environment 10 in which various aspects of the disclosure may be implemented includes one or more client machines 12A-12N, one or more remote machines 16A-16N, one or more networks 14, 14′, and one or more appliances 18 installed within the computing environment 10. The client machines 12A-12N communicate with the remote machines 16A-16N via the networks 14, 14′.

In some embodiments, the client machines 12A-12N communicate with the remote machines 16A-16N via an intermediary appliance 18. The illustrated appliance 18 is positioned between the networks 14, 14′ and may also be referred to as a network interface or gateway. In some embodiments, the appliance 18 may operate as an application delivery controller (ADC) to provide clients with access to business applications and other data deployed in a data center, the cloud, or delivered as Software as a Service (SaaS) across a range of client devices, and/or provide other functionality such as load balancing, etc. In some embodiments, multiple appliances 18 may be used, and the appliance(s) 18 may be deployed as part of the network 14 and/or 14′.

The client machines 12A-12N may be generally referred to as client machines 12, local machines 12, clients 12, client nodes 12, client computers 12, client devices 12, computing devices 12, endpoints 12, or endpoint nodes 12. The remote machines 16A-16N may be generally referred to as servers 16 or a server farm 16. In some embodiments, a client device 12 may have the capacity to function as both a client node seeking access to resources provided by a server 16 and as a server 16 providing access to hosted resources for other client devices 12A-12N. The networks 14, 14′ may be generally referred to as a network 14. The networks 14 may be configured in any combination of wired and wireless networks.

A server 16 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

A server 16 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions.

In some embodiments, a server 16 may execute a remote presentation services program or other program that uses a thin-client or a remote-display protocol to capture display output generated by an application executing on a server 16 and transmit the application display output to a client device 12.

In yet other embodiments, a server 16 may execute a virtual machine providing, to a user of a client device 12, access to a computing environment. The client device 12 may be a virtual machine. The virtual machine may be managed by, for example, a hypervisor, a virtual machine manager (VMM), or any other hardware virtualization technique within the server 16.

In some embodiments, the network 14 may be: a local-area network (LAN); a metropolitan area network (MAN); a wide area network (WAN); a primary public network 14; and a primary private network 14. Additional embodiments may include a network 14 of mobile telephone networks that use various protocols to communicate among mobile devices. For short range communications within a wireless local-area network (WLAN), the protocols may include 802.11, Bluetooth, and Near Field Communication (NFC).

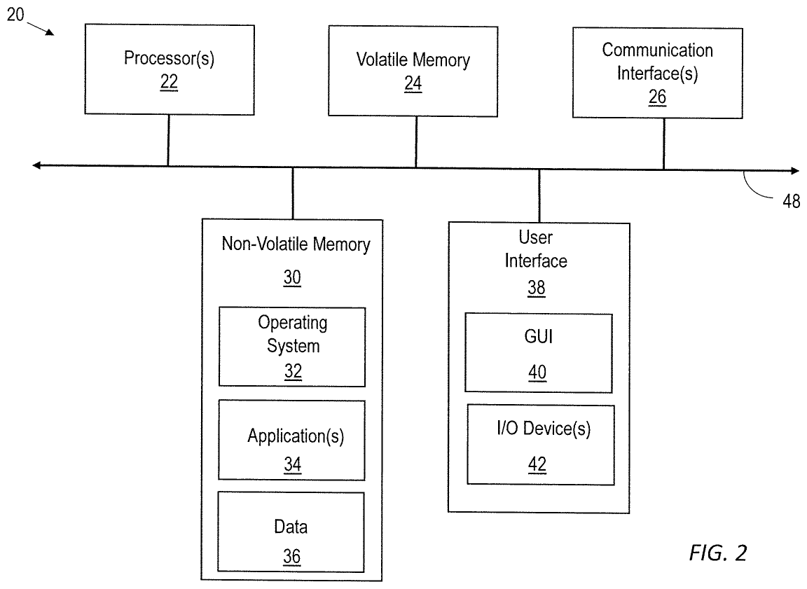

FIG. 2 depicts a block diagram of a computing device 20 useful for practicing an embodiment of client devices 12, appliances 18 and/or servers 16. The computing device 20 includes one or more processors 22, volatile memory 24 (e.g., random access memory (RAM)), non-volatile memory 30, user interface (UI) 38, one or more communications interfaces 26, and a communications bus 48.

The non-volatile memory 30 may include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

The user interface 38 may include a graphical user interface (GUI) 40 (e.g., a touchscreen, a display, etc.) and one or more input/output (I/O) devices 42 (e.g., a mouse, a keyboard, a microphone, one or more speakers, one or more cameras, one or more biometric scanners, one or more environmental sensors, and one or more accelerometers, etc.).

The non-volatile memory 30 stores an operating system 32, one or more applications 34, and data 36 such that, for example, computer instructions of the operating system 32 and/or the applications 34 are executed by processor(s) 22 out of the volatile memory 24. In some embodiments, the volatile memory 24 may include one or more types of RAM and/or a cache memory that may offer a faster response time than a main memory. Data may be entered using an input device of the GUI 40 or received from the I/O device(s) 42. Various elements of the computer 20 may communicate via the communications bus 48.

The illustrated computing device 20 is shown merely as an example client device or server, and may be implemented by any computing or processing environment with any type of machine or set of machines that may have suitable hardware and/or software capable of operating as described herein.

The processor(s) 22 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A processor may perform the function, operation, or sequence of operations using digital values and/or using analog signals.

In some embodiments, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory.

The processor 22 may be analog, digital or mixed-signal. In some embodiments, the processor 22 may be one or more physical processors, or one or more virtual (e.g., remotely located or cloud) processors. A processor including multiple processor cores and/or multiple processors may provide functionality for parallel, simultaneous execution of instructions or for parallel, simultaneous execution of one instruction on more than one piece of data.

The communications interfaces 26 may include one or more interfaces to enable the computing device 20 to access a computer network such as a Local Area Network (LAN), a Wide Area Network (WAN), a Personal Area Network (PAN), or the Internet through a variety of wired and/or wireless connections, including cellular connections.

In described embodiments, the computing device 20 may execute an application on behalf of a user of a client device. For example, the computing device 20 may execute one or more virtual machines managed by a hypervisor. Each virtual machine may provide an execution session within which applications execute on behalf of a user or a client device, such as a hosted desktop session. The computing device 20 may also execute a terminal services session to provide a hosted desktop environment. The computing device 20 may provide access to a remote computing environment including one or more applications, one or more desktop applications, and one or more desktop sessions in which one or more applications may execute.

An example virtualization server 16 may be implemented using Citrix Hypervisor provided by Citrix Systems, Inc., of Fort Lauderdale, Florida (“Citrix Systems”). Virtual app and desktop sessions may further be provided by Citrix Virtual Apps and Desktops (CVAD), also from Citrix Systems. Citrix Virtual Apps and Desktops is an application virtualization solution that enhances productivity with universal access to virtual sessions including virtual app, desktop, and data sessions from any device, plus the option to implement a scalable VDI solution. Virtual sessions may further include Software as a Service (SaaS) and Desktop as a Service (DaaS) sessions, for example.

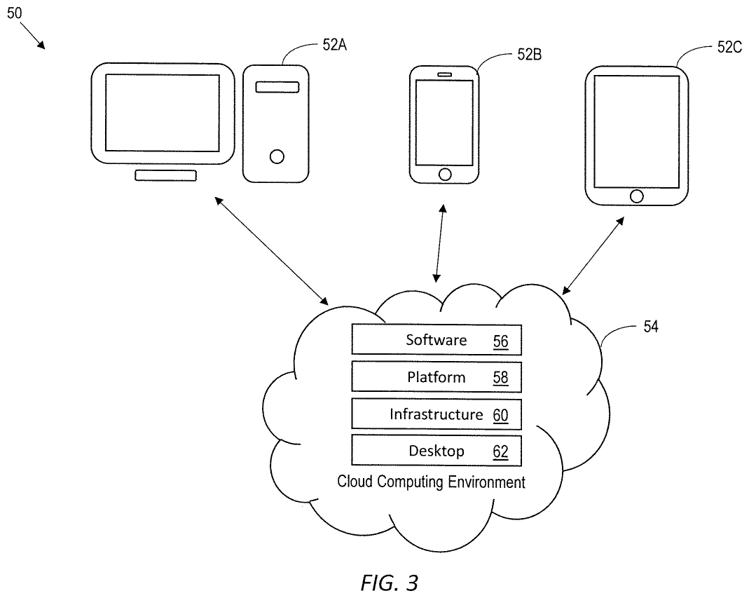

Referring to FIG. 3, a cloud computing environment 50 is depicted, which may also be referred to as a cloud environment, cloud computing or cloud network. The cloud computing environment 50 can provide the delivery of shared computing services and/or resources to multiple users or tenants. For example, the shared resources and services can include, but are not limited to, networks, network bandwidth, servers, processing, memory, storage, applications, virtual machines, databases, software, hardware, analytics, and intelligence.

In the cloud computing environment 50, one or more clients 52A-52C (such as those described above) are in communication with a cloud network 54. The cloud network 54 may include backend platforms, e.g., servers, storage, server farms or data centers. The users or clients 52A-52C can correspond to a single organization/tenant or multiple organizations/tenants. More particularly, in one example implementation the cloud computing environment 50 may provide a private cloud serving a single organization (e.g., enterprise cloud). In another example, the cloud computing environment 50 may provide a community or public cloud serving multiple organizations/tenants. In still further embodiments, the cloud computing environment 50 may provide a hybrid cloud that is a combination of a public cloud and a private cloud. Public clouds may include public servers that are maintained by third parties to the clients 52A-52C or the enterprise/tenant. The servers may be located off-site in remote geographical locations or otherwise.

The cloud computing environment 50 can provide resource pooling to serve multiple users via clients 52A-52C through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In some embodiments, the cloud computing environment 50 can provide on-demand self-service to unilaterally provision computing capabilities (e.g., server time, network storage) across a network for multiple clients 52A-52C. The cloud computing environment 50 can provide an elasticity to dynamically scale out or scale in responsive to different demands from one or more clients 52. In some embodiments, the computing environment 50 can include or provide monitoring services to monitor, control and/or generate reports corresponding to the provided shared services and resources.

In some embodiments, the cloud computing environment 50 may provide cloud-based delivery of different types of cloud computing services, such as Software as a service (SaaS) 56, Platform as a Service (PaaS) 58, Infrastructure as a Service (IaaS) 60, and Desktop as a Service (DaaS) 62, for example. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Washington, RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif.

PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Washington, Google App Engine provided by Google Inc., and HEROKU provided by Heroku, Inc. of San Francisco, Calif.

SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. DROPBOX provided by Dropbox, Inc. of San Francisco, Calif., Microsoft ONEDRIVE provided by Microsoft Corporation, Google Drive provided by Google Inc., or Apple ICLOUD provided by Apple Inc. of Cupertino, Calif.

Similar to SaaS, DaaS (which is also known as hosted desktop services) is a form of virtual desktop infrastructure (VDI) in which virtual desktop sessions are typically delivered as a cloud service along with the apps used on the virtual desktop. Citrix Cloud is one example of a DaaS delivery platform. DaaS delivery platforms may be hosted on a public cloud computing infrastructure such as AZURE CLOUD from Microsoft Corporation of Redmond, Washington (herein “Azure”), or AMAZON WEB SERVICES provided by Amazon.com, Inc., of Seattle, Washington (herein “AWS”), for example. In the case of Citrix Cloud, Citrix Workspace app may be used as a single-entry point for bringing apps, files and desktops together (whether on-premises or in the cloud) to deliver a unified experience.

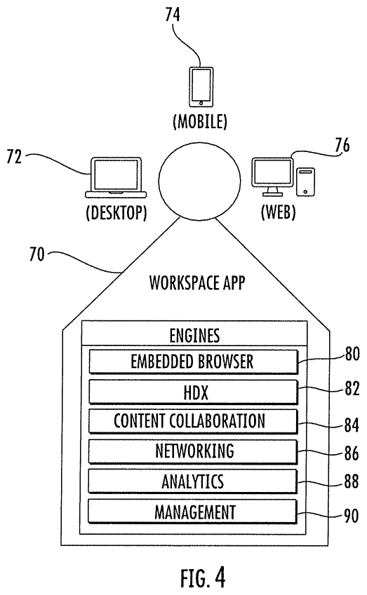

The unified experience provided by the Citrix Workspace app will now be discussed in greater detail with reference to FIG. 4. The Citrix Workspace app will be generally referred to herein as the workspace app 70. The workspace app 70 is how a user gets access to their workspace resources, one category of which is applications. These applications can be SaaS apps, web apps or virtual apps. The workspace app 70 also gives users access to their desktops, which may be a local desktop or a virtual desktop. Further, the workspace app 70 gives users access to their files and data, which may be stored in numerous repositories. The files and data may be hosted on Citrix ShareFile, hosted on an on-premises network file server, or hosted in some other cloud storage provider, such as Microsoft OneDrive or Google Drive Box, for example.

To provide a unified experience, all of the resources a user requires may be located and accessible from the workspace app 70. The workspace app 70 is provided in different versions. One version of the workspace app 70 is an installed application for desktops 72, which may be based on Windows, Mac or Linux platforms. A second version of the workspace app 70 is an installed application for mobile devices 74, which may be based on iOS or Android platforms. A third version of the workspace app 70 uses a hypertext markup language (HTML) browser to provide a user access to their workspace environment. The web version of the workspace app 70 is used when a user does not want to install the workspace app or does not have the rights to install the workspace app, such as when operating a public kiosk 76.

Each of these different versions of the workspace app 70 may advantageously provide the same user experience. This advantageously allows a user to move from client device 72 to client device 74 to client device 76 in different platforms and still receive the same user experience for their workspace. The client devices 72, 74 and 76 are referred to as endpoints.

As noted above, the workspace app 70 supports Windows, Mac, Linux, iOS, and Android platforms as well as platforms with an HTML browser (HTML5). The workspace app 70 incorporates multiple engines 80-90 allowing users access to numerous types of app and data resources. Each engine 80-90 optimizes the user experience for a particular resource. Each engine 80-90 also provides an organization or enterprise with insights into user activities and potential security threats.

An embedded browser engine 80 keeps SaaS and web apps contained within the workspace app 70 instead of launching them on a locally installed and unmanaged browser. With the embedded browser, the workspace app 70 is able to intercept user-selected hyperlinks in SaaS and web apps and request a risk analysis before approving, denying, or isolating access.

A high definition experience (HDX) engine 82 establishes connections to virtual browsers, virtual apps and desktop sessions running on either Windows or Linux operating systems. With the HDX engine 82, Windows and Linux resources run remotely, while the display remains local, on the endpoint. To provide the best possible user experience, the HDX engine 82 utilizes different virtual channels to adapt to changing network conditions and application requirements. To overcome high-latency or high-packet loss networks, the HDX engine 82 automatically implements optimized transport protocols and greater compression algorithms. Each algorithm is optimized for a certain type of display, such as video, images, or text. The HDX engine 82 identifies these types of resources in an application and applies the most appropriate algorithm to that section of the screen.

For many users, a workspace centers on data. A content collaboration engine 84 allows users to integrate all data into the workspace, whether that data lives on-premises or in the cloud. The content collaboration engine 84 allows administrators and users to create a set of connectors to corporate and user-specific data storage locations. This can include OneDrive, Dropbox, and on-premises network file shares, for example. Users can maintain files in multiple repositories and allow the workspace app 70 to consolidate them into a single, personalized library.

A networking engine 86 identifies whether or not an endpoint or an app on the endpoint requires network connectivity to a secured backend resource. The networking engine 86 can automatically establish a full VPN tunnel for the entire endpoint device, or it can create an app-specific p-VPN connection. A p-VPN defines what backend resources an application and an endpoint device can access, thus protecting the backend infrastructure. In many instances, certain user activities benefit from unique network-based optimizations. If the user requests a file copy, the workspace app 70 can automatically utilize multiple network connections simultaneously to complete the activity faster. If the user initiates a VoIP call, the workspace app 70 improves its quality by duplicating the call across multiple network connections. The networking engine 86 uses only the packets that arrive first.

An analytics engine 88 reports on the user's device, location and behavior, where cloud-based services identify any potential anomalies that might be the result of a stolen device, a hacked identity or a user who is preparing to leave the company. The information gathered by the analytics engine 88 protects company assets by automatically implementing counter-measures.

A management engine 90 keeps the workspace app 70 current. This not only provides users with the latest capabilities, but also includes extra security enhancements. The workspace app 70 includes an auto-update service that routinely checks and automatically deploys updates based on customizable policies.

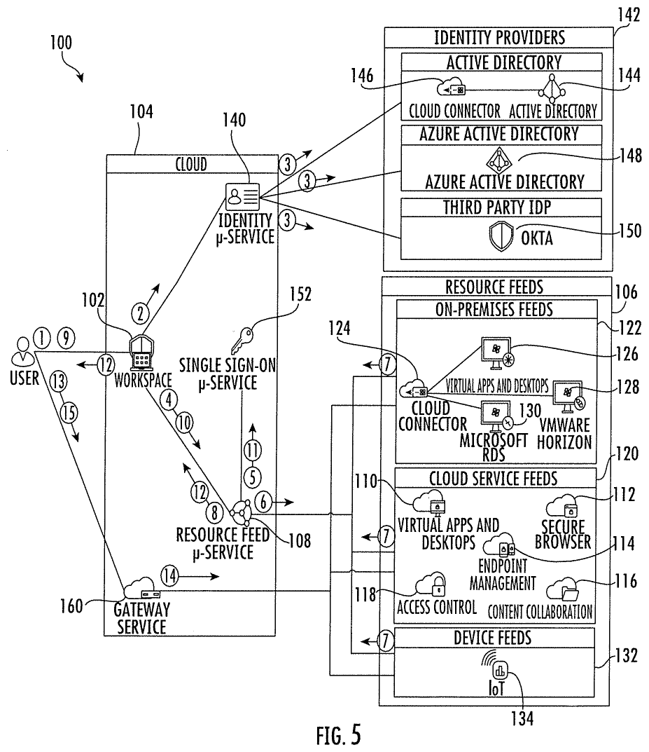

Referring now to FIG. 5, a workspace network environment 100 providing a unified experience to a user based on the workspace app 70 will be discussed. The desktop, mobile and web versions of the workspace app 70 all communicate with the workspace experience service 102 running within the Citrix Cloud 104. The workspace experience service 102 then pulls in all the different resource feeds via a resource feed micro-service 108. That is, all the different resources from other services running in the Citrix Cloud 104 are pulled in by the resource feed micro-service 108. The different services may include a virtual apps and desktop service 110, a secure browser service 112, an endpoint management service 114, a content collaboration service 116, and an access control service 118. Any service that an organization or enterprise subscribes to are automatically pulled into the workspace experience service 102 and delivered to the user's workspace app 70.

In addition to cloud feeds 120, the resource feed micro-service 108 can pull in on-premises feeds 122. A cloud connector 124 is used to provide virtual apps and desktop deployments that are running in an on-premises data center. Desktop virtualization may be provided by Citrix virtual apps and desktops 126, Microsoft RDS 128 or VMware Horizon 130, for example. In addition to cloud feeds 120 and on-premises feeds 122, device feeds 132 from Internet of Thing (IoT) devices 134, for example, may be pulled in by the resource feed micro-service 108. Site aggregation is used to tie the different resources into the user's overall workspace experience.

The cloud feeds 120, on-premises feeds 122 and device feeds 132 each provides the user's workspace experience with a different and unique type of application. The workspace experience can support local apps, SaaS apps, virtual apps, and desktops browser apps, as well as storage apps. As the feeds continue to increase and expand, the workspace experience is able to include additional resources in the user's overall workspace. This means a user will be able to get to every single application that they need access to.

Still referring to the workspace network environment 20, a series of events will be described on how a unified experience is provided to a user. The unified experience starts with the user using the workspace app 70 to connect to the workspace experience service 102 running within the Citrix Cloud 104, and presenting their identity (event 1). The identity includes a user name and password, for example.

The workspace experience service 102 forwards the user's identity to an identity micro-service 140 within the Citrix Cloud 104 (event 2). The identity micro-service 140 authenticates the user to the correct identity provider 142 (event 3) based on the organization's workspace configuration. Authentication may be based on an on-premises active directory 144 that requires the deployment of a cloud connector 146. Authentication may also be based on Azure Active Directory 148 or even a third party identity provider 150, such as Citrix ADC or Okta, for example.

Once authorized, the workspace experience service 102 requests a list of authorized resources (event 4) from the resource feed micro-service 108. For each configured resource feed 106, the resource feed micro-service 108 requests an identity token (event 5) from the single-sign micro-service 152.

The resource feed specific identity token is passed to each resource's point of authentication (event 6). On-premises resources 122 are contacted through the Citrix Cloud Connector 124. Each resource feed 106 replies with a list of resources authorized for the respective identity (event 7).

The resource feed micro-service 108 aggregates all items from the different resource feeds 106 and forwards (event 8) to the workspace experience service 102. The user selects a resource from the workspace experience service 102 (event 9).

The workspace experience service 102 forwards the request to the resource feed micro-service 108 (event 10). The resource feed micro-service 108 requests an identity token from the single sign-on micro-service 152 (event 11). The user's identity token is sent to the workspace experience service 102 (event 12) where a launch ticket is generated and sent to the user.

The user initiates a secure session to a gateway service 160 and presents the launch ticket (event 13). The gateway service 160 initiates a secure session to the appropriate resource feed 106 and presents the identity token to seamlessly authenticate the user (event 14). Once the session initializes, the user is able to utilize the resource (event 15). Having an entire workspace delivered through a single access point or application advantageously improves productivity and streamlines common workflows for the user.

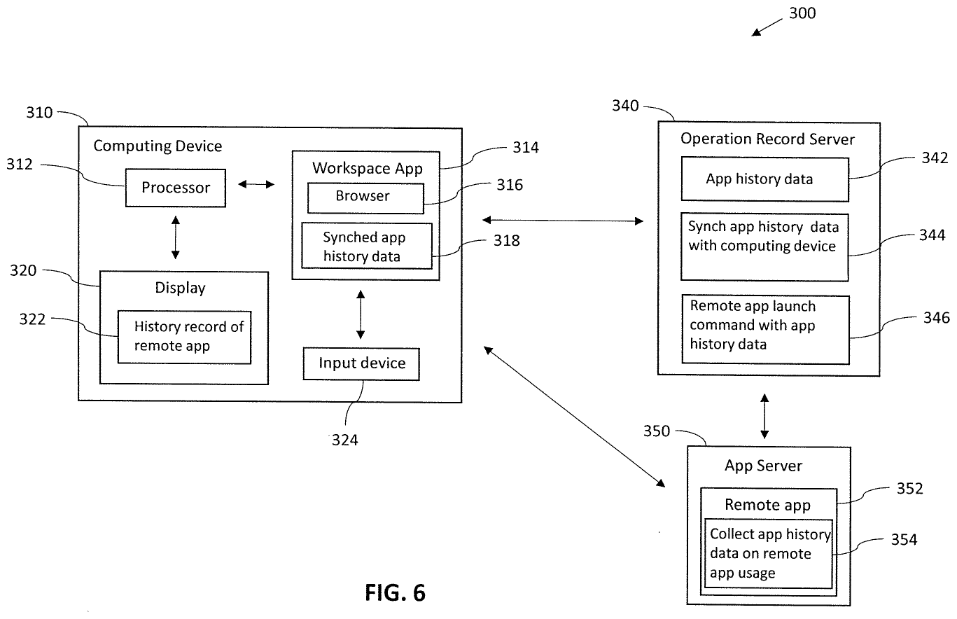

Referring now to FIG. 6, a computer system 300 providing a shortcut to launch a remote app 352 restored back to an item previously handled by a user of a computing device 310 will now be discussed. The shortcut is based on displaying a history record 322 of the remote app 352 to the user of the computing device 310. The history record 322 provides a preview of items previously handled by the user with the remote app 352, and is synched with app history data 342 stored in an operation record server 340.

In response to the user selecting a displayed item in the history record 322, the operation record server 340 sends a launch command 346 to an app server 350 with the remote app 352. The launch command 346 includes app history data 342 associated with the selected item. This allows the remote app 352 to be launched so that a work scene for the item previously handled by the user is restored.

The user is now able to continue where they left off with the selected item. Restoring the selected item previously handled by the user is advantageously performed without any additional user input after the user selects the item in the displayed history record 322.

Without the above shortcut, additional steps are needed for a user to return to an item previously handled by the remote app 352. Currently, when a user returns to their computing device 310, the user is able to view a recent apps area in their workspace. The recent apps area allows a user to launch the apps and access previous items handled by the user with the apps.

For example, the user first opens the desired remote app that includes the item, and then navigates to a displayed title corresponding to the item. To restore the remote app to the item, the user selects a URL linked to the title or finds the title in a history list of the remote app itself.

As will be discussed in greater detail below, the user is able to restore a work scene in a remote app 352 by selecting the item from the displayed history record 322 of the remote app 352. The selected item from the displayed history record 322 is synched with the app history data 342 stored in the operation record server 340 to provide the shortcut for launching the remote app 352 with the app history data 342. The app history data 342 allows the remote app 352 to restore the work scene for the item previously handled by the user.

The illustrated computer system 300 includes the computing device 310, the operation record server 340, and the app server 350 providing the remote app 352. Even though only one computing device 310 is illustrated, the computer system 300 typically includes a plurality of computing devices 310. Such computing devices 310 generally operate within an enterprise or organization.

The remote app 352 may be a SaaS app or web app accessed by the user of the computing device 310 to perform various activities or tasks. The app is remote since it is not stored on the computing device 310.

The remote app 352, for example, may be used to create Jira tickets. Jira is provided by Atlassian, and is used for bug tracking, issue tracking, and project management. A ticket in Jira, or any other service desk platform, is an event that needs to be investigated or a work item that needs to be addressed.

Other example remote apps 352 include SalesForce provided by SalesForce.com, Inc. and Slack provided by Slack Technologies. SalesForce provides customer relationnship management (CRM) services, and Slack provides instant messaging within a workplace.

The operation record server 340 is in communications with the computing device 310 and the app server 350. The operation record server 340 may be configured as a microservice within the enterprise or organization. A microservice is an architectural style that configures the function of the operation record server 340 as a set of small services. Each service runs in its own process. The services communicate with the computing device 310 and the app server 350 using lightweight protocols, often over messaging or HTTP.

The operation record server 340 includes an app history data database to store the collected app history data 342 on usage of the remote app 352. The remote app 352 is instructed to collect the app history data 354. In response to the user closing the remote app 352, the collected app history data 354 is reported to the operation record server 340 for storage in the app history data database.

The remote app 352 is not modified, but instead, a rule is defined so that history data 354 on remote app usage is reported to an interface. In this case, the interface is associated with the operation record server 340.

Using Jira as an example, the user accesses the remote app 352 to generate a Jira ticket with id JIRA-001. The remote app 352 collects app history data 354 on generation of the Jira ticket. When the user closes the remote app 352, the collected app history data 354 is reported to the operation record server 340.

The format of the app history data 354 may vary between different remote apps 352. Still using the Jira ticket with id JIRA-001 as an example, the app history data 354 may be in the following format:

```
{
  history_view_title : JIRA-001
  history_meta_data :
  {
    id : xxx
    url : xxx
    xxx : xxx
  }
  history_xxx: xxx
}
```

The above history view title is determined and generated by the remote app 352, which is JIRA-001 in this example. The history metadata is a set of data that describes and gives information about other data within the JIRA-001 ticket. Many distinct types of metadata exist, including descriptive metadata, structural metadata, administrative metadata, reference metadata, statistical metadata and legal metadata.

For instance, the structural metadata is metadata about containers of data and indicates how compound objects are put together. It describes the types, versions, relationships and other characteristics of the JIRA-001 ticket. The reference metadata is information about the contents of the JIRA-001 ticket. Since the app history data 354 is reported by the remote app 352 itself, this allows enough information to be reported to the operation record server 340 to restore the work scene to where the user left off.

The operation record server 340 synchs 344 the stored app history data 342 with the computing device 310. The app history data 342 may be synched with the local workspace on the computing device 310. The computing device 310 includes the workspace app 70, as discussed above, which provides the local workspace. The workspace app 70 is executed by a processor 312 so that the user gets access to their workspace resources, one category of which is the remote apps 352.

The workspace app 70 includes a browser 316 to access the remote app 352. The browser 316 may be a managed browser. The source code in the managed browser 364 is modified to add functionality to synch 318 with the app history data 342 in the operation record server 340. In one embodiment, the workspace app 70 uses the history view titles from the operation record server 340 to build up the titles for each item displayed in the history record 322.

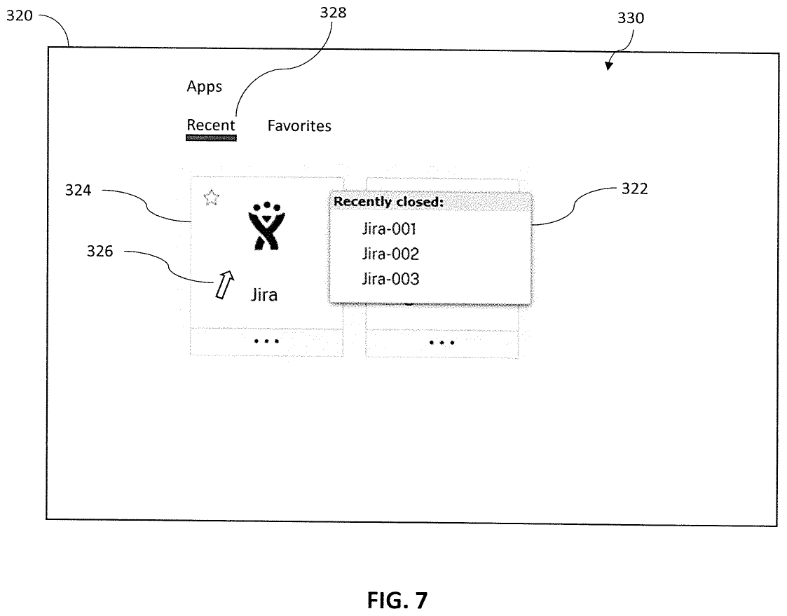

An example history record 322 of the remote app 352 will now be discussed in reference to FIG. 7. The history record 322 is for a Jira remote application 352 previously accessed by the user of the computing device 310. The history record 322 is displayed in response to the user using the input device 324 to position a cursor 326 over a Jira icon 324 representing the Jira remote app 352.

The Jira icon 324 may be displayed in response to the user viewing the recent apps area 328 that is part of the local workspace 330. The user selects or highlights the Jira remote app 352 by positioning the cursor 326 over the Jira icon 324. The cursor 326 is an indicator used to show the current position for user interaction on the display 320.

In response to the user positioning the cursor 326 over the Jira icon 324, the history record 322 is displayed without user input. The history record 322 provides a preview of the items previously handled by the user with the Jira remote app 352. In this example, the user previously reviewed or edited three Jira tickets: JIRA-001, JIRA-002 and JIRA-003.

The history record 322 includes the respective titles as determined by the Jira remote app 352. The user selects one of the Jira tickets by moving the cursor 326 over the corresponding title, and clicking the input device 324 used to guide the cursor 326.

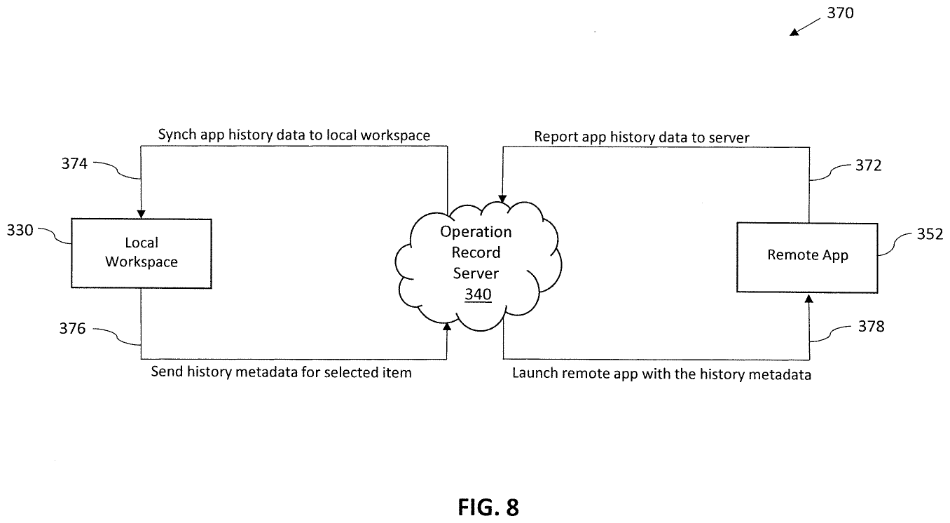

A high level sequence diagram 370 showing operation of the computing system 300 is provided in FIG. 8. To start, the remote app 352 reports history data 354 on usage of the remote app to the operation record server 340 at line 372. The history data 354 is reported in response to the user of the computing device 310 closing the remote app 352.

The operation record server 340 then synchs the app history data 342 with the local workspace 330 of the computing device 310 at line 374. The local workspace 330 uses the history view titles from the app history data 342 to build up the titles in the history record 322.

When the user wants to return to an item previously handled by the remote app 352, the item is displayed in the record history 322. The record history 322 is displayed in response to the user positioning a cursor 326 over the icon 324 of the remote app 352.

The users selects the desired item displayed in the history record 322. In response, the local workspace 330 sends metadata at line 376 associated with the synch app history data 318 for the selected item to the operation record server 340. The metadata is a subset of the metadata associated with the app history data 342 being stored on the operation record server 340.

The operation record server 340 uses the received metadata to send a launch command 346 to the remote app 352 at line 378. The received metadata is associated with the corresponding metadata being stored on the operation record server 340 for the selected item. The remote app 352 is then launched with the metadata associated with the selected item so that the remote app 352 is restored to where the user last left off with the selected item.

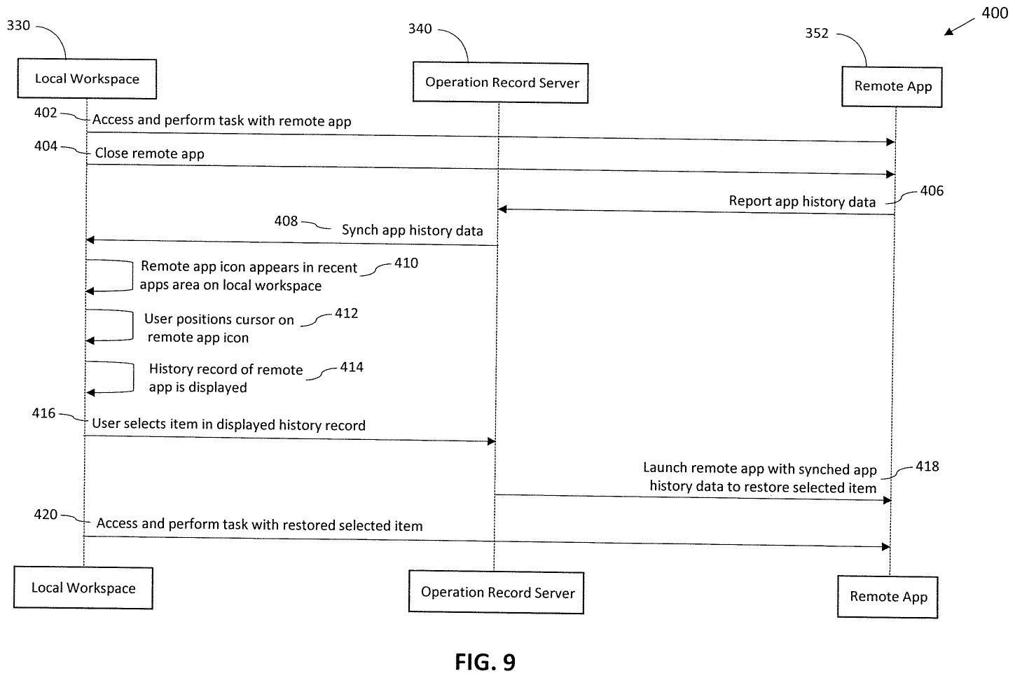

A more detailed sequence diagram 400 showing operation of the computing system 300 is provided in FIG. 9. The user first accesses and performs a task with the remote app 352 at line 402. The browser 316 operating in the local workspace 330 of the computing device 310 communicates directly with the remote app 352. That is, the operation record server 340 is bypassed.

The user closes the remote app 352 at line 404 when the user is finished performing tasks with the remote app 352. In response to the remote app 352 being closed, the remote app reports app history data 354 on usage of the remote app at line 406 to the operation record server 340. The app history data 354 as reported by the remote app 352 includes metadata associated with the tasks performed by the user with the remote app 352.

The operation record server 340 at line 408 synchs the app history data 342 with the local workspace 330. The local workspace 330 uses the metadata associated with the app history data 342 to generate the synched 318 app history data. The metadata includes, for example, the history view titles from the items handled by the user with the remote app 352.

The closed remote app 352 now appears in the recent apps area 328 in the local workspace 330 at line 410. When the user wants to return to an item previously handled by the remote app 352, the user positions a cursor 326 over the icon 324 of the remote app 352 at line 412. In response to the cursor 326 being position over the icon 324, the history record 322 of the remote app 352 is displayed at line 414.

The users selects the desired item displayed in the history record 322 at line 416. In response, the local workspace 330 sends metadata associated with the synch app history data 318 for the selected item to the operation record server 340 at line 418. This causes the remote app 352 to be launched with the metadata associated with the selected item so that the remote app 352 is restored to where the user last left off with the selected item. The user is now able to access and perform tasks with the restored selected item at line 420.

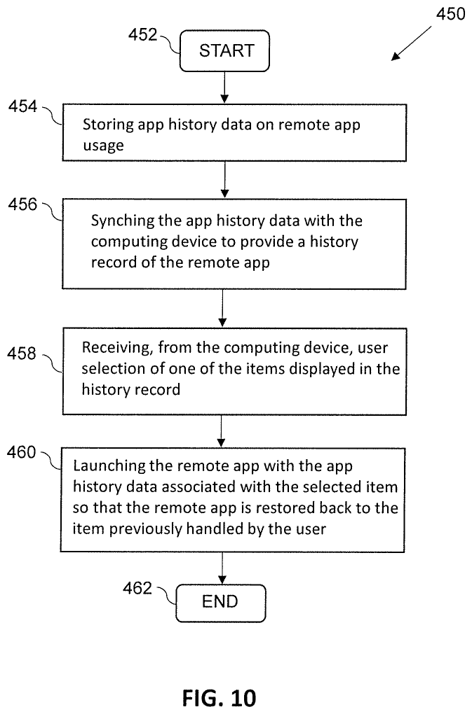

Referring now to FIG. 10, a flowchart 450 illustrating a method for operating the operation record server 340 will be discussed. From the start (Block 452), the method includes storing app history data 342 at Block 454. The app history data 342 is provided by a remote app 352 corresponding to items previously handled by a user of a computing device 310 with the remote app 352.

The app history data 342 is synched with the computing device 310 at Block 456. The synched app history data 318 provides a history record 322 of the remote app 3523. The history record 322 provides a preview of the items previously handled by the user with the remote app 352.

The operation record server 340 receives from the computing device 310 user selection of one of the items previously handled by the user with the remote app 352 at Block 458. The remote app 352 is launched at Block 460 with the app history data 342 associated with the selected item so that the remote app 352 is restored back to the item previously handled by the user. The method ends at Block 462.

As will be appreciated by one of skill in the art upon reading the above disclosure, various aspects described herein may be embodied as a device, a method or a computer program product (e.g., a non-transitory computer-readable medium having computer executable instruction for performing the noted operations or steps). Accordingly, those aspects may take the form of an entirely hardware embodiment, an entirely software embodiment, or an embodiment combining software and hardware aspects.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof.

Many modifications and other embodiments will come to the mind of one skilled in the art having the benefit of the teachings presented in the foregoing descriptions and the associated drawings. Therefore, it is understood that the foregoing is not to be limited to the example embodiments, and that modifications and other embodiments are intended to be included within the scope of the appended claims.

1. A server comprising:
a memory configured to store app history data provided by a remote app corresponding to items previously handled by a user of a computing device with the remote app; and
a processor coupled to said memory and configured to perform the following:
synch the app history data with the computing device to provide a history record of the remote app, with the history record providing a preview of the items previously handled by the user with the remote app,
receive, from the computing device, user selection of one of the items previously handled by the user with the remote app, and
launch the remote app with the app history data associated with the selected item so that the remote app is restored back to the item previously handled by the user.

2. The server according to claim 1 wherein said memory receives the app history data form the remote app in response to the user of the computing device closing the remote app.

3. The server according to claim 2 wherein said memory does not receive the app history data while the user is performing a task with the restored selected item.

4. The server according to claim 2 wherein the stored app history data is updated each time the remote app is closed.

5. The server according to claim 1 wherein the app history data comprises metadata.

6. The server according to claim 1 wherein the app history data comprises a respective title for each item previously handled by the user with the remote app, and wherein synching the app history data is based on providing the respective title for each item to the computing device.

7. The server according to claim 6 wherein the respective title for each item is linked to the app history data associated with that item.

8. The server according to claim 6 wherein the history record includes the respective title for each item, with the preview of the items previously handled by the user including the respective title for each item.

9. The server according to claim 6 wherein the user selection of one of the items received by said processor corresponds to the respective title associated with the selected item.

10. The server according to claim 1 wherein each item previously handled by the user of the computing device is based on the remote app receiving user input so that activities are performed by the remote app.

11. The server according to claim 1 wherein the remote app comprises at least one of a SaaS app and a web app.

12. A method comprising:
storing app history data provided by a remote app corresponding to items previously handled by a user of a computing device with the remote app;
synching the app history data with the computing device to provide a history record of the remote app, with the history record providing a preview of the items previously handled by the user with the remote app;
receiving, from the computing device, user selection of one of the items previously handled by the user with the remote app; and
launching the remote app with the app history data associated with the selected item so that the remote app is restored back to the item previously handled by the user.

13. The method according to claim 12 wherein the app history data is received in response to the user of the computing device closing the remote app.

14. The method according to claim 13 wherein the app history data is not received while the user is performing a task with the restored selected item.

15. The method according to claim 12 wherein the app history data comprises metadata.

16. The method according to claim 12 wherein the app history data comprises a respective title for each item previously handled by the user with the remote app, and wherein synching the app history data is based on providing the respective title for each item to the computing device.

17. The method according to claim 16 wherein the respective title for each item is linked to the app history data associated with that item.

18. The method according to claim 16 wherein the history record includes the respective title for each item, with the preview of the items previously handled by the user including the respective title for each item.

19. The method according to claim 12 wherein each item previously handled by the user of the computing device is based on the remote app receiving user input so that activities are performed by the remote app.

20. A computing system comprising:
a computing device configured to perform the following:
select a remote app to be launched based on user input,
display a history record of the selected remote app, with the history record providing a preview of items previously handled by the user with the remote app, and
select one of the items based on user input; and
an operation record server configured to perform the following:
store app history data provided by the remote app corresponding to the items previously handled by the user with the remote app, and
launch the remote app with the app history data associated with the selected item so that the remote app is restored back to the item previously handled by the user.
